(19) United States
(12) Patent Application Publication
(10) Pub. No.: US 2012/0269161 A1
(43) Pub. Date: Oct. 25, 2012

(54) Method and Apparatus for Relaxing Uplink and Downlink RF Switching

(75) Inventors: Tom Chin, San Diego, CA (US); Guangming Shi, San Diego, CA (US); Kuo-Chun Lee, San Diego, CA (US)

(73) Assignee: Qualcomm Incorporated, San Diego, CA (US)

(21) Appl. No.: 13/384,195

(22) PCT Filed: Mar. 31, 2010
(86) PCT No.: PCT/US10/29522

§ 371 Date: Jan. 13, 2012

Related U.S. Application Data
(60) Provisional application No. 61/261,075, filed on Nov. 13, 2009.

(51) Int. Cl. H04W 72/04

(52) U.S. Cl. 370/330; 370/335

(57) ABSTRACT

A method and apparatus are disclosed to enable user equipment in a TD-SCDMA network to reduce or eliminate RF signal leakage from a transmitter to a receiver. In an aspect of the disclosure, a method includes receiving an assignment of an uplink time slot of a sub-frame and receiving an assignment of a downlink time slot of the sub-frame, wherein the uplink time slot is prevented from being sequential to the downlink time slot. In another aspect of the disclosure, a method includes receiving an assignment of an uplink time slot of a sub-frame associated with a first carrier frequency and receiving an assignment of a down-link time slot of a sub-frame associated with a second carrier frequency, wherein the first carrier frequency is prevented from being the same frequency as the second carrier frequency when the uplink time slot is sequential to the downlink time slot.

### CROSS-REFERENCE TO RELATED APPLICATION(S)

This application claims the benefit of U.S. Provisional Patent Application No. 61/261,075, entitled “SYSTEM AND METHOD FOR RELAXING THE UPLINK AND DOWNLINK RF SWITCHING IN A TD-SCDMA TERMINAL DEVICE,” filed on Nov. 13, 2009, which is expressly incorporated by reference herein in its entirety.

### BACKGROUND

1. Field

Aspects of the present disclosure relate generally to wireless communication systems, and more particularly, to resource allocation in a TD-SCDMA system.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communication protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

Various aspects of the instant disclosure enable the UE device hardware to reduce or eliminate RF signal leakage from a transmitter to a receiver. Thus, systems and methods according to this disclosure may enable relaxed hardware constraints and increased data transmission performance.

In an aspect of the disclosure, a method used in a TD-SCDMA communication system includes receiving an assignment of an uplink time slot of a sub-frame and receiving an assignment of a downlink time slot of the sub-frame, wherein the uplink time slot is prevented from being sequential to the downlink time slot.

In another aspect of the disclosure, a method used in a TD-SCDMA communication system includes receiving an assignment of an uplink time slot of a sub-frame associated with a first carrier frequency and receiving an assignment of a downlink time slot of a sub-frame associated with a second carrier frequency, wherein the first carrier frequency is prevented from being the same frequency as the second carrier frequency when the uplink time slot is sequential to the downlink time slot.

In yet another aspect of the disclosure, an apparatus for wireless communication used in a TD-SCDMA system includes means for receiving an assignment of an uplink time slot of a sub-frame, means for receiving an assignment of a downlink time slot of the sub-frame, and means for preventing the uplink time slot from being sequential to the downlink time slot.

In yet another aspect of the disclosure, an apparatus for wireless communication used in a TD-SCDMA system includes means for receiving an assignment of an uplink time slot of a sub-frame associated with a first carrier frequency, means for receiving an assignment of a downlink time slot of a sub-frame associated with a second carrier frequency, and means for preventing the first carrier frequency from being the same frequency as the second carrier frequency when the uplink time slot is sequential to the downlink time slot.

In yet another aspect of the disclosure, a computer program product used in a TD-SCDMA wireless communication system includes a computer-readable medium comprising code for receiving an assignment of an uplink time slot of a sub-frame, receiving an assignment of a downlink time slot of the sub-frame, and preventing the uplink time slot from being sequential to the downlink time slot.

In yet another aspect of the disclosure, a computer program product used in a TD-SCDMA wireless communication system includes a computer-readable medium comprising code for receiving an assignment of an uplink time slot of a sub-frame associated with a first carrier frequency, receiving an assignment of a downlink time slot of a sub-frame associated with a second carrier frequency, and preventing the first carrier frequency from being the same frequency as the second carrier frequency when the uplink time slot is sequential to the downlink time slot.

In yet another aspect of the disclosure, an apparatus for wireless communication in a TD-SCDMA system includes at least one processor and a memory coupled to the at least one processor, wherein the at least one processor is configured to receive an assignment of an uplink time slot of a sub-frame, to receive an assignment of a downlink time slot of the sub-frame, and to prevent the uplink time slot from being sequential to the downlink time slot.

In yet another aspect of the disclosure, an apparatus for wireless communication in a TD-SCDMA system includes at least one processor and a memory coupled to the at least one processor, wherein the at least one processor is configured to receive an assignment of an uplink time slot of a sub-frame associated with a first carrier frequency, to receive an assignment of a downlink time slot of a sub-frame associated with a second carrier frequency, and to prevent the first carrier frequency from being the same frequency as the second carrier frequency when the uplink time slot is sequential to the downlink time slot.

### BRIEF DESCRIPTION OF THE DRAWINGS

FIG. 1 is a block diagram conceptually illustrating an example of a telecommunication system.

FIG. 2 is a block diagram conceptually illustrating an example of a frame structure in a telecommunication system.

FIG. 3 is a block diagram conceptually illustrating an example of a Node B in communication with a UE in a telecommunication system.

FIG. 4 is a diagram conceptually illustrating the timing of UL and DL communications in sequential time slots.

FIG. 5 is a diagram conceptually illustrating an overlap between UL and DL communications in sequential time slots.

FIG. 6 is a diagram conceptually illustrating an assignment of an UL time slot and a DL time slot according to an aspect of the disclosure.

FIG. 7 is a diagram conceptually illustrating an assignment of an UL time slot and a DL time slot in different frequency carriers according to an aspect of the disclosure.

FIGS. 8-9 are flow charts conceptually illustrating processes of assigning UL and DL time slots according to aspects of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

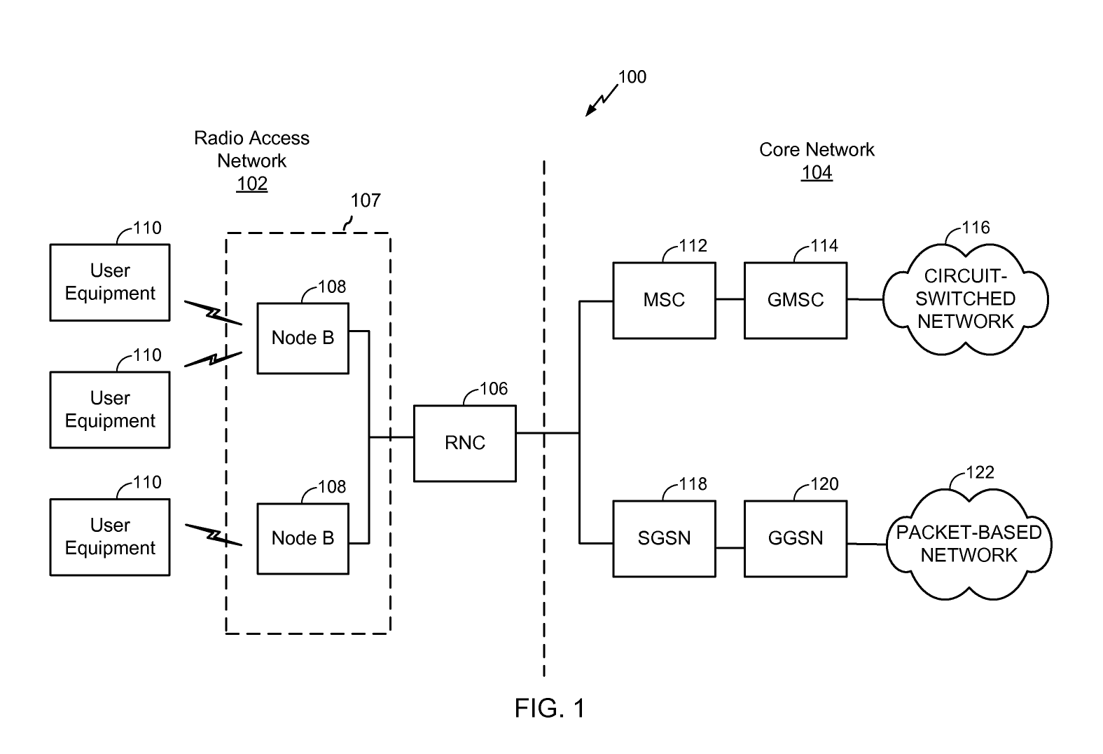

Turning now to FIG. 1, a block diagram is shown illustrating an example of a telecommunication system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

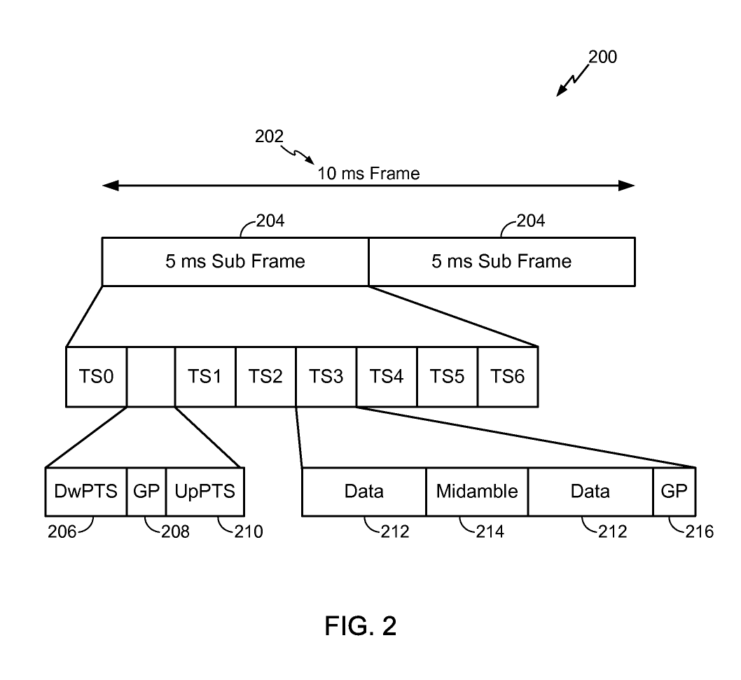

FIG. 2 shows a frame structure 200 for a TD-SCDMA carrier. The TD-SCDMA carrier, as illustrated, has a frame 202 that is 10 ms in length. The frame 202 has two 5 ms sub-frames 204, and each of the sub-frames 204 includes seven time slots, TS0 through TS6. The first time slot, TS0, may be allocated for downlink communication over common channels such as the Primary Common Control Physical Channel (P-CCPCH), and/or the downlink Dedicated Physical Channel (DL DPCH), while the second time slot, TS1, may be allocated for uplink communication. The remaining time slots, TS2 through TS6, may be used for either uplink or downlink, which allows for greater flexibility during times of higher data transmission times in either the uplink or downlink directions. Time slots TS1-TS6 may be used for Dedicated Physical Channels (DPCHs). A downlink pilot time slot (DwPTS) 206, a guard period (GP) 208, and an uplink pilot time slot (UpPTS) 210 (also known as the uplink pilot channel (UpPCH)) are located between TS0 and TS1.

Each time slot, TS0-TS6, may allow data transmission multiplexed on a maximum of 16 code channels. Data transmission on a code channel includes two data portions 212, each of which may include 352 chips, separated by a midamble 214, which may include 144 chips, and followed by a guard period (GP) 216, which may include 16 chips. The midamble 214 may be used for features such as channel estimation, while the GP 216 may be used to avoid inter-burst interference and to provide a buffer for any timing errors in the equipment.

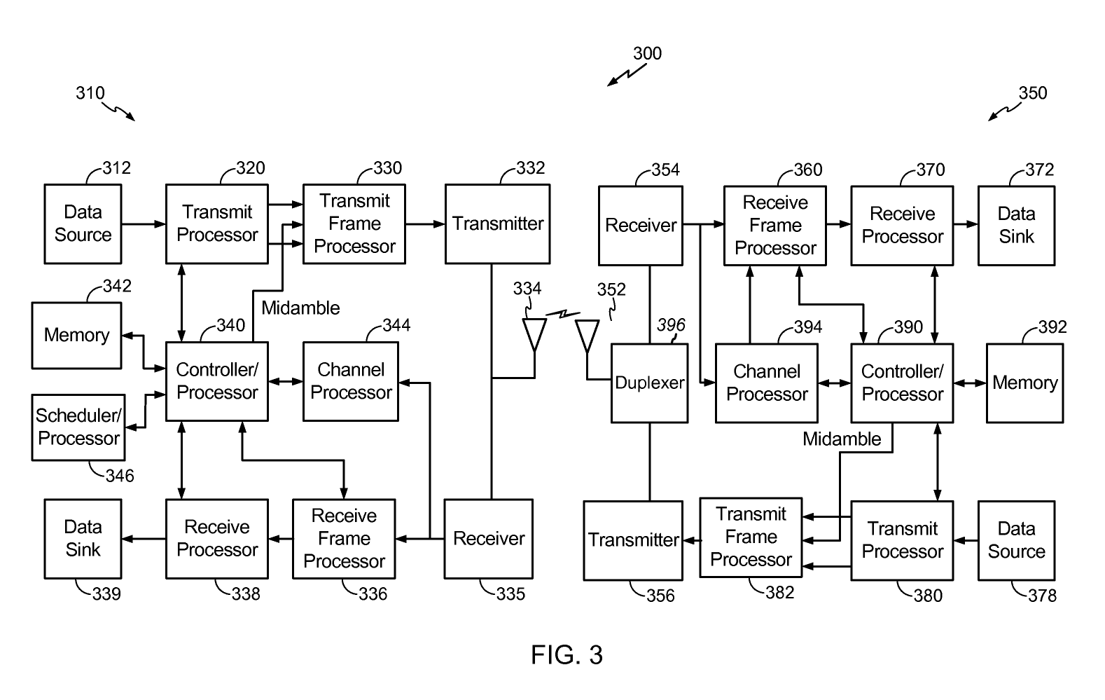

FIG. 3 is a block diagram illustrating one example of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. Those skilled in the art will comprehend that the blocks shown in FIG. 3 are illustrative in nature, and in various implementations the blocks may represent discrete or integrated hardware components, and multiple ones of the blocks may be integrated together into one or more ASICs.

In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 includes a receive chain that receives the downlink transmission through an antenna 352 and processes the transmission to recover the information modulated onto the carrier. Block 354 may include various components of an RF front end, such as a matching circuit, a bandpass filter, a low-noise amplifier, a mixer, and a baseband component (e.g., a baseband ASIC) and/or an intermediate frequency component. The information recovered by the receiver 354 is provided to the receive frame processor 360, which parses each frame, and provides the midamble 214 (FIG. 2) to a channel processor 394 and the data, control, and reference signals to the receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to the transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to the transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to the transmitter 356, which includes a transmit chain that provides various signal conditioning functions including amplification, filtering, and modulating the frames onto a carrier for uplink transmission over the wireless medium through the antenna 352.

Duplexer 396 is coupled between the antenna 352 and the receiver 354 and transmitter 356. Duplexer 396 functions to allocate antenna 352 resources to the receiver 354 or the transmitter 356, enabling bi-directional communication over the air interface between UE 350 and Node B 310.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

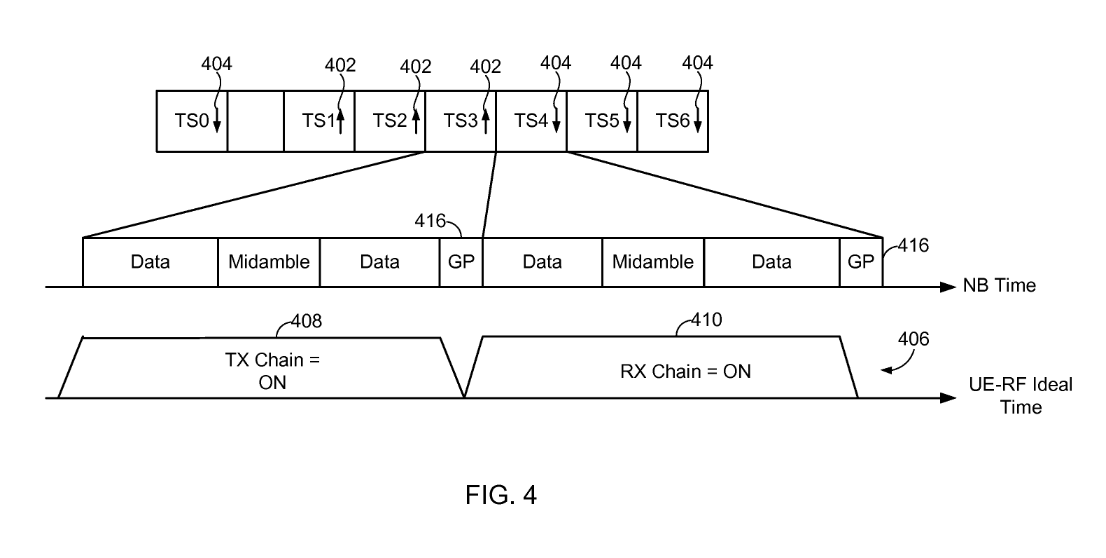

FIG. 4 is a diagram illustrating an example data frame in which time slots TS1, TS2, and TS3 are utilized for uplink (UL) communication on the UL DPCH, indicated by the up arrows 402, and time slots TS4, TS5, and TS6 are utilized for downlink (DL) communication on the DL DPCH, indicated by the down arrows 404. Those skilled in the art will comprehend that other allocations of time slots as a UL time slot or a DL time slot may be utilized. In some cases, as illustrated in FIG. 4, TS0 may be also be assigned for DL DPCH. In various aspects, the UL time slots may start from TS1, and the DL time slots may start from any of TS2-TS6 after the end of all UL time slots. However, for the purpose of illustration, as illustrated in FIG. 4, the UE changes from UL at TS3 to DL at TS4.

In the same way as the 16-chip GP 216 in FIG. 2, the GP 416 of FIG. 4 enables the RF circuitry to switch direction if needed. For example, as illustrated in FIG. 4, when one UE is allocated with a UL DPCH in TS3 and a DL DPCH in TS4, then this UE generally turns off the transmitter 356 and turns on its receiver 354 within this small GP 416 at the end of the TS3. Otherwise, there may be RF signal leakage from the transmitter 356 to the receiver 354.

The timing diagram 406 at the bottom of FIG. 4 illustrates RF switching according to an ideal case. That is, in the ideal case, the receiver 354 may only be turned on after the transmitter 356 has completed turning off, such that the receiver 354 is substantially unaffected by the transmitter 356. Thus, in the timing diagram 406, there is no overlap between the portion 408 labeled “TX Chain=ON” and the portion 410 labeled “RX Chain=ON.”

However, it may be challenging to switch the RF from the transmitter 356 to the receiver 354 during the relatively short, 16-chip GP. This is especially an issue when there is a timing error or imperfect uplink synchronization. Therefore, the transmitter 356 may not turn off instantaneously, but may degrade relatively slowly when switched off. Thus, if the transmitter 356 is still at least partially on when the receiver 354 is turned on, the receiver 354 may receive a relatively high-power transmission from the transmitter 356, causing bit errors and other potential issues. For an RF leakage-sensitive application that may require a relatively high quality of service, such as a voice call, such a condition may lead to unacceptable levels of errors that may be difficult or impossible to remedy by means such as forward error correction.

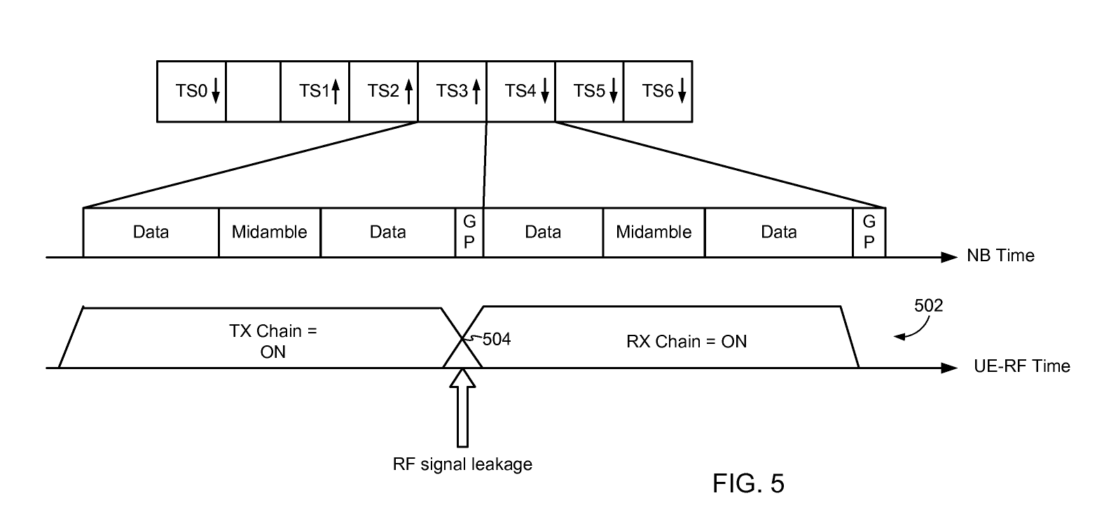

FIG. 5 includes a timing diagram 502 that illustrates this issue, showing an overlap 504 between the time when the transmitter 356 and the receiver 354 are turned on, resulting in RF signal leakage from the transmitter 356 to the receiver 354.

In such a case, it may be difficult for a UE to switch from a UL TS to a DL TS while avoiding any RF leakage from the transmitter 356 to the receiver 354 unless the RF switch/duplexer 396 is designed to have very high rejection. Further the UE may have high performance requirements in order to meet the timing constraints. These and other requirements may increase the expense of the device.

Thus, in an exemplary aspect of the disclosure, a rule may be applied to prevent an uplink time slot from being sequential to a downlink time slot in the same sub-frame. Here, the term “sequential” may refer to time slots that occur in sequence in a radio frame, not including TS0, since the pilot time slots DwPTS and UpPTS occur between TS0 and TS1. For example, TSn and TSn+1 may be referred to as “sequential” for n>0. Thus, TS0 and TS1 may not be “sequential” according to this definition. Further, the term “sequential” is not intended to be limited to any particular order; thus, TS2 may be considered sequential to TS1 and sequential to TS3.

For example, the rule may be such that the UE may not utilize the last uplink time slot and the first time slot (whichever time slot this may be, e.g., TS2-TS6) for DPCH in the same radio frame. Instead, if the UE utilizes the last uplink time slot, then the UE may only utilize a downlink time slot being between the second downlink time slot and the last downlink time slot, inclusive, for DPCH. In another example, when the UE utilizes the first downlink time slot, then the UE may not utilize the last uplink time slot, but may utilize any uplink time slot other than the last uplink time slot for DPCH. In other words, the UL for a particular UE should not be allocated a time slot that is adjacent to a time slot that is allocated for the DL for that particular UE. Rather, at least one inactive time slot may be maintained for that particular UE between the UL time slot and the DL time slot. Here, an inactive TS refers to a TS that is not allocated to the particular UE, but the inactive TS may be allocated by the NB to be actively utilized for other UEs.

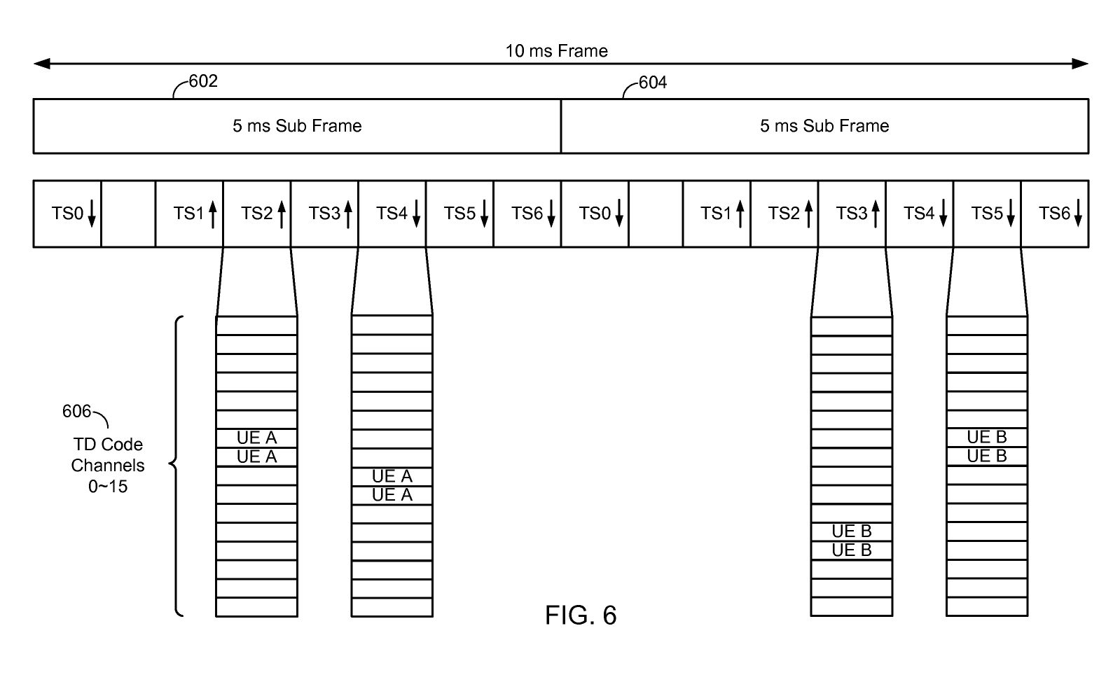

FIG. 6 is a diagram that schematically illustrates two examples of this resource allocation. The figure shows two UEs (UE A and UE B) that are allocated with non-sequential DL and UL time slots. In the first sub-frame 602, TS3 is an inactive time slot between TS2, utilized for the UL from UE A, and TS4, utilized for the DL to UE A. TS3 may be utilized for an UL for a different UE, e.g., UE C. In the second sub-frame 604, TS4 is an inactive time slot between TS3, utilized for the UL from UE B, and TS5, utilized for the DL to UE B. TS 4 may be utilized for an UL for a different UE, e.g., UE D. Such a resource allocation enables the UE to have more time to turn off the transmitter 356 and avoid the transmission signal leaking into the receiver 354.

It should be noted that this illustration in FIG. 6 only shows allocation to UE A during the first sub-frame 602, and allocation to UE B during the second sub-frame 604; however, either one or both of UE A and UE B may utilize both sub-frames, and indeed may utilize the same time slots in one or both sub-frames, by virtue of the utilization of different channelization codes 606.

Another aspect of the instant disclosure takes advantage of the fact that TD-SCDMA systems in general may utilize multiple carriers. That is, a typical air interface may have three times 1.6 MHz bandwidth to enable 3 carriers of operation.

Thus, in an exemplary aspect of the disclosure, the UE may be allocated with the DPCH in sequential time slots, e.g., in the last UL TS and the first DL TS among TS2-TS6 of the sub-frame, if and only if the sequential time slots are on different carriers. Here, if the transmitter 356 is on during a time that overlaps with a time when the receiver 354 is on, because the RF leakage signal from the transmitter 356 to the receiver 354 is in different carriers, it may be very easy to filter out any UL leakage.

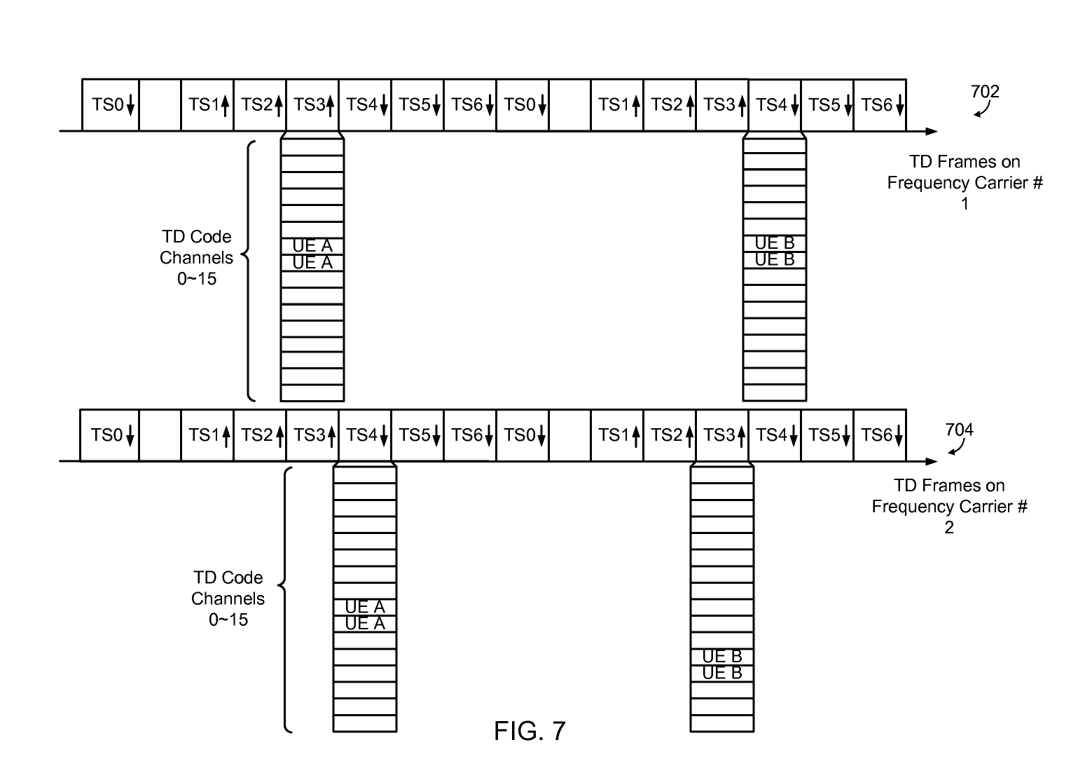

FIG. 7 illustrates two examples of this resource allocation, showing simultaneous radio frames on two carriers 702 and 704. For example, UE A is allocated a DPCH for its UL in TS3 in frequency carrier #1, and a DPCH for its DL in the sequential time slot, TS4, in frequency carrier #2. Here, UE A may have some UL RF leakage after the end of TS3 on frequency carrier #1, when the DL RF may be turned on before the beginning of TS4 on frequency carrier #2. However, the leakage may easily be rejected by filtering out the signal of frequency carrier #1 when the DL is on frequency carrier #2. Similarly, UE B is allocated a DPCH for its UL in TS3 in frequency carrier #2, and a DPCH for its DL in the sequential time slot, TS4, in frequency carrier #1.

Thus, referring again to FIG. 3, in one configuration, the apparatus 350 for wireless communication includes means for receiving assignments of time slots for UL and DL DPCH, and means for preventing the UL time slot from being sequential to the DL time slot. In another configuration, the apparatus 350 for wireless communication includes means for receiving assignments of time slots for UL and DL DPCH on first and second carrier frequencies, respectively, and means for preventing the first carrier frequency from being the same frequency as the second carrier frequency when the UL time slot is sequential to the DL time slot. In one aspect, the aforementioned means may be the processor(s) 390 in the apparatus 350, configured to perform the functions recited by the aforementioned means. In another aspect, the aforementioned means may be the processor 340 in the Node B 310, configured to perform the functions recited by the aforementioned means. In yet another aspect, the aforementioned means may be an RNC 106 (see FIG. 1), or any other suitable module or any apparatus configured to perform the functions recited by the aforementioned means.

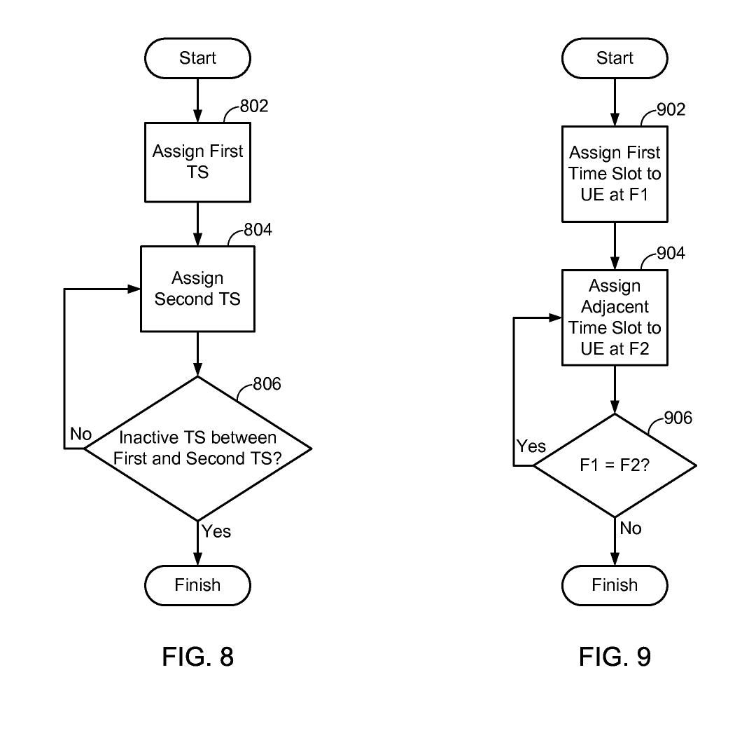

FIGS. 8 and 9 are flow charts illustrating processes according to aspects of the instant disclosure. FIG. 8 represents a process according to an aspect of the disclosure wherein the uplink time slot is prevented from being sequential to the downlink time slot. In block 802, a first time slot may be assigned. In some aspects, this time slot may be allocated for UL or DL communications. Further, according to various aspects of the disclosure the allocation may be performed by the UE, by the Node B, or by essentially any other entity in the access network or core network. In block 804, a second time slot is assigned. Here, the second time slot is for DL communications if the first time slot is for UL communications, or the second time slot is for UL communications if the first time slot is for DL communication. In block 806, the process determines whether there is at least one inactive time slot between the first time slot and the second time slot, and if yes, the process ends. However, if there is not at least one inactive time slot between the first time slot and the second time slot, the process returns to block 804, and the second time slot is re-assigned such as to arrive at the condition that there is at least one inactive time slot between the first and second time slots. Of course, those skilled in the art will comprehend that this loop is not the only process that may be utilized to arrive at the result wherein the uplink time slot is not sequential to the downlink time slot.

FIG. 9 represents a process according to an aspect of the disclosure wherein a first carrier frequency in which an uplink time slot is assigned is prevented from being the same frequency as a second carrier frequency in which a downlink time slot is assigned when the uplink time slot is sequential to the downlink time slot. In block 902, a first time slot may be assigned at a first frequency carrier F1. In block 904, a second, sequential time slot is assigned at a second frequency carrier F2. In block 906, the process determines whether the first frequency carrier is equal to the second frequency carrier, and if yes, the process returns to block 904 to re-assign the second time slot until the process arrives at a condition that the first frequency carrier is different from the second frequency carrier. Of course, one skilled in the art will comprehend that this loop is not the only process that may be utilized to arrive at the result wherein the first carrier frequency is a different frequency than the second carrier frequency when the uplink time slot is sequential to the downlink time slot.

Several aspects of a telecommunication system have been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method used in a TD-SCDMA communication system, the method comprising:
receiving an assignment of an uplink time slot of a sub-frame; and
receiving an assignment of a downlink time slot of the sub-frame,
wherein the uplink time slot is prevented from being sequential to the downlink time slot.

2. The method of claim 1, wherein the uplink time slot and the downlink time slot are utilized for an RF leakage-sensitive application.

3. The method of claim 2, wherein the RF leakage-sensitive application comprises a voice call.

4. The method of claim 1,
wherein the first time slot is within a first carrier frequency, and the second time slot is within a second carrier frequency, and
wherein the first carrier frequency is the same carrier frequency as the second carrier frequency.

5. The method of claim 4, wherein the first time slot corresponds to at least one uplink channel for the mobile terminal, and the second time slot corresponds to at least one downlink channel for the mobile terminal.

6. A method used in a TD-SCDMA communication system, the method comprising:
receiving an assignment of an uplink time slot of a sub-frame associated with a first carrier frequency; and
receiving an assignment of a downlink time slot of a sub-frame associated with a second carrier frequency,
wherein the first carrier frequency is prevented from being the same frequency as the second carrier frequency when the uplink time slot is sequential to the downlink time slot.

7. The method of claim 6, wherein the uplink time slot and the downlink time slot are utilized for an RF leakage-sensitive application.

8. The method of claim 7, wherein the RF leakage-sensitive application comprises a voice call.

9. The method of claim 6, wherein the first time slot is sequential to the second time slot.

10. The method of claim 9, wherein the first time slot corresponds to at least one uplink channel for the mobile terminal, and the second time slot corresponds to at least one downlink channel for the mobile terminal.

11. An apparatus for wireless communication used in a TD-SCDMA system, the apparatus comprising:
means for receiving an assignment of an uplink time slot of a sub-frame;
means for receiving an assignment of a downlink time slot of the sub-frame; and
means for preventing the uplink time slot from being sequential to the downlink time slot.

12. The apparatus of claim 11, wherein the uplink time slot and the downlink time slot are utilized for an RF leakage-sensitive application.

13. The apparatus of claim 12, wherein the RF leakage-sensitive application comprises a voice call.

14. The apparatus of claim 11,
wherein the first time slot is within a first carrier frequency, and the second time slot is within a second carrier frequency, and
wherein the first carrier frequency is the same carrier frequency as the second carrier frequency.

15. The apparatus of claim 14, wherein the first time slot corresponds to at least one uplink channel for the mobile terminal, and the second time slot corresponds to at least one downlink channel for the mobile terminal.

16. An apparatus for wireless communication used in a TD-SCDMA system, the apparatus comprising:
means for receiving an assignment of an uplink time slot of a sub-frame associated with a first carrier frequency;
means for receiving an assignment of a downlink time slot of a sub-frame associated with a second carrier frequency; and
means for preventing the first carrier frequency from being the same frequency as the second carrier frequency when the uplink time slot is sequential to the downlink time slot.

17. The apparatus of claim 16, wherein the uplink time slot and the downlink time slot are utilized for an RF leakage-sensitive application.

18. The apparatus of claim 17, wherein the RF leakage-sensitive application comprises a voice call.

19. The apparatus of claim 16, wherein the first time slot is sequential to the second time slot.

20. The apparatus of claim 19, wherein the first time slot corresponds to at least one uplink channel for the mobile terminal, and the second time slot corresponds to at least one downlink channel for the mobile terminal.

21. A computer program product used in a TD-SCDMA wireless communication system, comprising:
a computer-readable medium comprising code for:
receiving an assignment of an uplink time slot of a sub-frame;
receiving an assignment of a downlink time slot of the sub-frame; and
preventing the uplink time slot from being sequential to the downlink time slot.

22. The computer program product of claim 21, wherein the uplink time slot and the downlink time slot are utilized for an RF leakage-sensitive application.

23. The computer program product of claim 22, wherein the RF leakage-sensitive application comprises a voice call.

24. The computer program product of claim 21,
wherein the first time slot is within a first carrier frequency, and the second time slot is within a second carrier frequency, and
wherein the first carrier frequency is the same carrier frequency as the second carrier frequency.

25. The computer program product of claim 24, wherein the first time slot corresponds to at least one uplink channel for the mobile terminal, and the second time slot corresponds to at least one downlink channel for the mobile terminal.

26. A computer program product used in a TD-SCDMA wireless communication system, comprising:
a computer-readable medium comprising code for:
receiving an assignment of an uplink time slot of a sub-frame associated with a first carrier frequency;
receiving an assignment of a downlink time slot of a sub-frame associated with a second carrier frequency; and
preventing the first carrier frequency from being the same frequency as the second carrier frequency when the uplink time slot is sequential to the downlink time slot.

27. The computer program product of claim 26, wherein the uplink time slot and the downlink time slot are utilized for an RF leakage-sensitive application.

28. The computer program product of claim 27, wherein the RF leakage-sensitive application comprises a voice call.

29. The computer program product of claim 26, wherein the first time slot is sequential to the second time slot.

30. The computer program product of claim 29, wherein the first time slot corresponds to at least one uplink channel for the mobile terminal, and the second time slot corresponds to at least one downlink channel for the mobile terminal.

31. An apparatus for wireless communication in a TD-SCDMA system, comprising:
at least one processor; and
a memory coupled to the at least one processor,
wherein the at least one processor is configured to:
receive an assignment of an uplink time slot of a sub-frame;
receive an assignment of a downlink time slot of the sub-frame; and
prevent the uplink time slot from being sequential to the downlink time slot.

32. The apparatus of claim 31, wherein the uplink time slot and the downlink time slot are utilized for an RF leakage-sensitive application.

33. The apparatus of claim 32, wherein the RF leakage-sensitive application comprises a voice call.

34. The apparatus of claim 31,
wherein the first time slot is within a first carrier frequency, and the second time slot is within a second carrier frequency, and
wherein the first carrier frequency is the same carrier frequency as the second carrier frequency.

35. The apparatus of claim 34, wherein the first time slot corresponds to at least one uplink channel for the mobile terminal, and the second time slot corresponds to at least one downlink channel for the mobile terminal.

36. An apparatus for wireless communication in a TD-SCDMA system, comprising:
at least one processor; and
a memory coupled to the at least one processor,
wherein the at least one processor is configured to:
receive an assignment of an uplink time slot of a sub-frame associated with a first carrier frequency;
receive an assignment of a downlink time slot of a sub-frame associated with a second carrier frequency; and
prevent the first carrier frequency from being the same frequency as the second carrier frequency when the uplink time slot is sequential to the downlink time slot.

37. The apparatus of claim 36, wherein the uplink time slot and the downlink time slot are utilized for an RF leakage-sensitive application.

38. The apparatus of claim 37, wherein the RF leakage-sensitive application comprises a voice call.

39. The apparatus of claim 36, wherein the first time slot is sequential to the second time slot.

40. The apparatus of claim 39, wherein the first time slot corresponds to at least one uplink channel for the mobile terminal, and the second time slot corresponds to at least one downlink channel for the mobile terminal.
